(19) United States
(12) Patent Application Publication
(10) Pub. No.: US 2012/0120953 A1
(43) Pub. Date: May 17, 2012

(54) SYSTEM AND METHOD FOR DISCOVERING COMMUNICATION ENTITY USING DISCOVERY GATEWAY

(75) Inventors: Soo Hyung LEE, Daejeon (KR); Jae Hyuk KIM, Seoul (KR); Won-Tae KIM, Chungnam (KR); Seung-Min PARK, Daejeon (KR)

(73) Assignee: ELECTRONICS AND TELECOMMUNICATIONS RESEARCH INSTITUTE, Daejeon (KR)

(21) Appl. No.: 13/286,648

(22) Filed: Nov. 1, 2011

(30) Foreign Application Priority Data
Nov. 2, 2010 (KR) 10-2010-0108148

(51) Int. Cl. H04L 12/56

(52) U.S. Cl. 370/390

(57) ABSTRACT

A method includes, when a passage network connecting at least one first communication entity in a first local domain with at least one second communication entity in a second local domain does not support the broadcast scheme and the multicast scheme, transmitting, by a first discovery gateway, a discovery request to a second discovery gateway, which is one of all discovery gateways connected with the first discovery gateway, in the second local domain via the passage network. Even when a passage network that does not support broadcasting and multicasting is between two communication entities, the method enables a communication entity to search for connection information about a counterpart communication entity without information required for communication entities requiring interaction on a network to connect with each other, thereby performing a function such as data exchange and service provision at a global level.

### CLAIM FOR PRIORITY

This application claims priority to Korean Patent Application No. 10-2010-0108148 filed on Nov. 2, 2010 in the Korean Intellectual Property Office (KIPO), the entire contents of which are hereby incorporated by reference.

### BACKGROUND

1. Technical Field

Example embodiments of the present invention relate in general to a system and method for discovering a communication entity using at least one of a multicast scheme and a broadcast scheme, and more particularly, to a system and method for communication entities participating in an application domain to discover each other for setting up mutual communication connection using a multicast or broadcast scheme.

2. Related Art

If the communication entities were able to directly recognize each other or if the information to make connection between entities was managed, a communication connection could be directly established on the basis of the managed information.

However, a drastic increase in the number of communication entities participating in an application domain also results in a drastic increase in the exchanged data types and the number of provided services. For this reason, it is difficult for an individual node to manage all communication entities. Also, since the data and the services provided by a specific node can change according to its state, it is difficult for each node to set or to manage the information about the counterpart entities to be connected in advance.

Thus, a method has emerged, which recognizes a communication entity from/to which data or service will be requested/provided, and discovers connection information about the recognized communication entity at a point in time when request for/provision of the data or service is actually needed.

The method of discovering a communication entity should find the connection information about a target entity and the service or data provided by target entity. To this end, two methods are frequently used. In the first method, information related to a communication connection is requested from communication entities participating in an application using the multicast/broadcast scheme, and then the response is sent. In the to second method, the data or service information to be provided/requested by a communication entity is registered in a central server and can be exchanged later to obtain the information to set up connection between communication entities.

In the second method, when the central server does not operate normally, it is difficult to perform overall application. The first method enables distributed processing, and thus a malfunctioning node has little effect on overall application. However, when a network for connecting communication entities participating in an application domain does not support broadcasting or multicasting, it is difficult to use the first method.

### SUMMARY

Accordingly, example embodiments of the present invention are provided to substantially obviate one or more problems due to limitations and disadvantages of the related art.

Example embodiments of the present invention provide a system and method for enabling communication entities participating in an application domain to mutually discover connection information about counterpart communication entities when the communication entities participating in the application domain are present on first and second different local networks, and the first and second local networks are connected via a passage network that does not support multicasting and broadcasting.

Example embodiments of the present invention also provide an apparatus for providing simulation results using image information without an additional application for examining the simulation results.

In some example embodiments, a method of discovering a communication entity using at least one of a multicast scheme and a broadcast scheme includes: when a passage network connecting at least one first communication entity in a first local domain with at least one second communication entity in a second local domain does not support the to broadcast scheme and the multicast scheme, transmitting, by a first discovery gateway, a discovery request to a second discovery gateway, which is one of all discovery gateways connected with the first discovery gateway, in the second local domain via the passage network. Transmitting, by the first discovery gateway, the discovery request to the second discovery gateway in the second local domain via the passage network may include transmitting, by the first discovery gateway, a discovery request message to the second discovery gateway using a unicast scheme. The method may further include transmitting, by the first communication entity, a discovery request message to the first discovery gateway in the first local domain. Transmitting, by the first communication entity, the discovery request message to the first discovery gateway in the first local domain may include transmitting, by the first communication entity, the discovery request message to the first discovery gateway in the first local domain through group communication. Transmitting, by the first discovery gateway, the discovery request to the second discovery gateway in the second local domain via the passage network may include: when communication entities in the first local domain belong to a multicasting group, transmitting, by the first communication entity, the discovery request to the communication entities belonging to the multicasting group in the first local domain through group communication using the multicast scheme; and when the communication entities in the first local domain do not belong to a multicasting group, transmitting, by the first communication entity, the discovery request to all the communication entities in the first local domain through group communication using the broadcast scheme. The method may further include recognizing, by the first discovery gateway provided in the first local domain and the second discovery gateway provided in the second local domain, each other. The first and second discovery gateways may be provided in a method of distinguishing a local network from information about all networks in which communication entities participating in an application to provide a discovery gateway for the local network. The first discovery gateway may be integrally implemented with a network to device for interoperation between a first local network in the first local domain and the passage network. The first discovery gateway may transmit the discovery request to the second local domain after analyzing a result of discovery in the first local domain. The first discovery gateway may simultaneously transmit the discovery request to the first local domain and the second local domain. The method may further include processing, by the second discovery gateway, the discovery request with the second communication entity in the second local domain using one of the multicast scheme and the broadcast scheme. Processing, by the second discovery gateway, the discovery request with the second communication entity in the second local domain using one of the multicast scheme and the broadcast scheme may include: when the second discovery gateway receives the discovery request from the first gateway, transmitting, by the second discovery gateway as a requestor, the discovery request to at least one communication entity in the second local domain using one of the multicast scheme and the broadcast scheme; receiving, by the second discovery gateway, a discovery response message from at least one communication entity in the second local domain using a unicast scheme; and when no connection information or result is discovered in a second local network, transmitting, by the second discovery gateway, a discovery response message indicating that there is no connected communication entity to the first discovery gateway using the unicast scheme.

In other example embodiments, a communication entity discovery system for performing a method of discovering a communication entity using at least one of a multicast scheme and a broadcast scheme includes: at least one first communication entity in a first local domain; and a first discovery gateway provided in the first local domain. Here, when a passage network connecting the at least one first communication entity with at least one second communication entity in a second local domain does not support the broadcast scheme and the multicast scheme, the first communication entity transmits a discovery request message to the first discovery gateway, and the first discovery gateway transmits a to discovery request to a second discovery gateway, which is one of all discovery gateways connected with the first discovery gateway, in the second local domain via the passage network.

### BRIEF DESCRIPTION OF DRAWINGS

Example embodiments of the present invention will become more apparent by describing in detail example embodiments of the present invention with reference to the accompanying drawings, in which:

FIG. 1 is a schematic block diagram of a conventional communication entity discovery system;

FIG. 2 is a flowchart illustrating a conventional communication entity discovery method of discovering communication entity connection information;

FIG. 3 is a schematic block diagram of a system for discovering a communication entity according to an example embodiment of the present invention;

FIG. 4 is a flowchart illustrating a method of discovering a communication entity using a discovery gateway according to an example embodiment of the present invention;

FIG. 5 is a detailed flowchart illustrating the method of discovering a communication entity using a discovery gateway illustrated in FIG. 4; and

FIG. 6 is a conceptual diagram illustrating an example of a network environment to which a method of discovering a communication entity using a discovery gateway according to an example embodiment of the present invention is applied, and provision of discovery gateways.

### DESCRIPTION OF EXAMPLE EMBODIMENTS OF THE PRESENT INVENTION

Example embodiments of the present invention are disclosed herein. However, specific structural and functional details disclosed herein are merely representative for to purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” with another element, it can be directly connected or coupled with the other element or intervening elements may be present. In contrast, when an element is referred to as being “directly connected” or “directly coupled” with another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly to indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently, or the blocks may sometimes be executed in the reverse order, depending upon the functionality/acts involved.

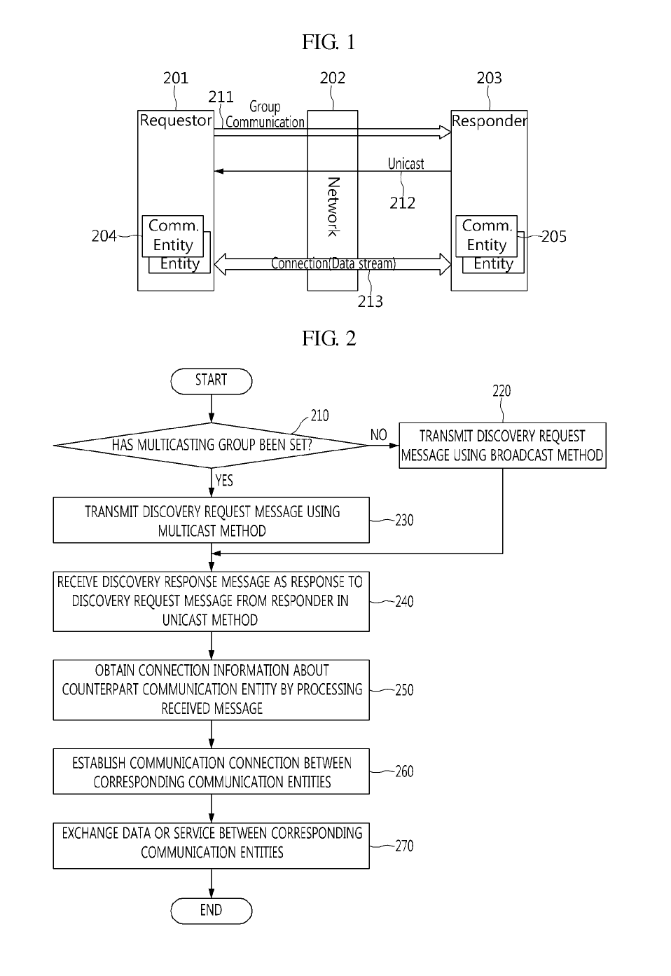

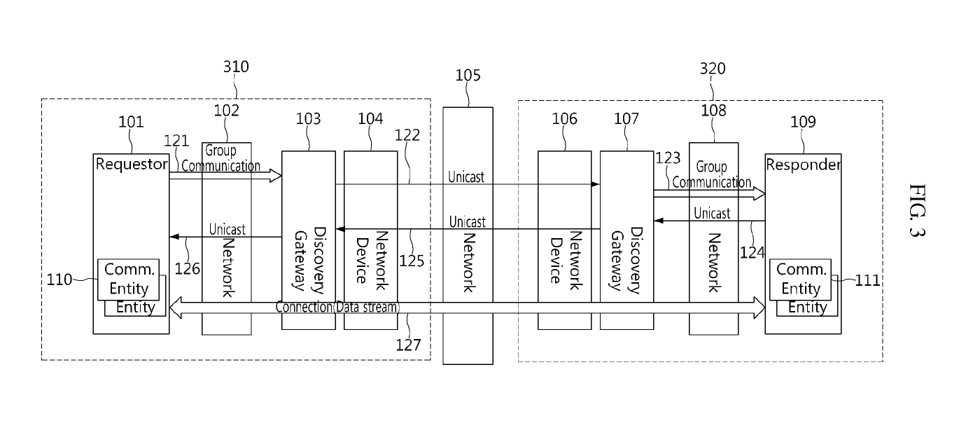

First, a general communication entity discovery method of discovering a counterpart communication entity using a multicast scheme or a broadcast scheme will be described with reference to FIGS. 1 and 2.

FIG. 1 is a schematic block diagram of a conventional communication entity discovery system, and FIG. 2 is a flowchart illustrating a conventional communication entity discovery method of discovering communication entity connection information.

Referring to FIG. 1, a conventional communication entity discovery system includes a requestor 201 that makes a discovery request, a responder 203 that responds to the discovery request, and a network 202 that connects the requestor 201 with the responder 203.

The requestor 201 refers to a communication node including a communication entity 204 that has first transmitted a discovery request message. The requestor 201 may be any communication node that actually requests or provides data or service.

The responder 203 refers to a communication node including a communication entity 205 that receives the discovery request message, and transmits a discovery response message including connection information about the communication entity 205 when the communication entity 205 has provided or requested data or service indicated in the discovery request message.

The communication entities 204 and 205 refer to one logical execution object that requests or provides data or service from or to another communication entity to perform a specific function participating in an application domain on an actual communication node, and actually performs communication connection in order to request or provide the data or the service.

It is assumed that the requestor 201 and the responder 203 are connected via the network 202 providing a multicast or broadcast function. In a wired/wireless local area network (LAN), which is the most basic network, a communication medium is shared between communication nodes to basically provide a broadcast function and the resultant multicast function.

A process of a conventional communication entity discovery method will be described below with reference to FIG. 2.

First, it is determined whether or not a multicasting group of communication nodes (or communication entities) participating in an application domain has been set (step 210).

When it is determined that a multicasting group has been set, the requestor 201 transmits a discovery request message to the communication nodes in the group through a group communication channel 211 using a multicast scheme (step 230).

On the other hand, when it is determined that no multicasting group has been set, the requestor 201 transmits the discovery request message to all communication nodes connected to the network 202 through the group communication channel 211 using a broadcast scheme (step 220).

The requestor 201 receives a response message to the discovery request message from the responder 203 through a unicast channel 212 using a unicast scheme (step 240), and obtains connection information about the counterpart communication entity by processing the discovery response message (step 250). Subsequently, communication connection for data or service exchange is performed through a data channel 213 between the communication entities (step 260), and data or service exchange for application is actually performed through the data channel 213 between the communication entities (step 270).

A method of discovering a communication entity using a discovery gateway according to an example embodiment of the present invention will be described below with reference to FIGS. 3 to 6.

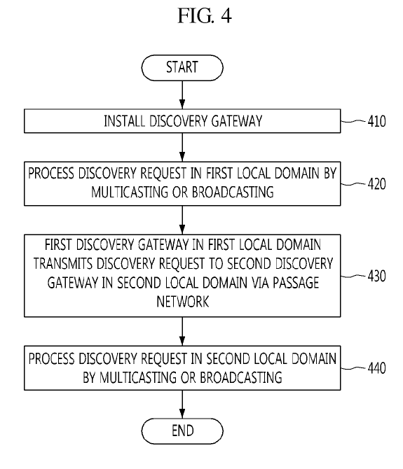

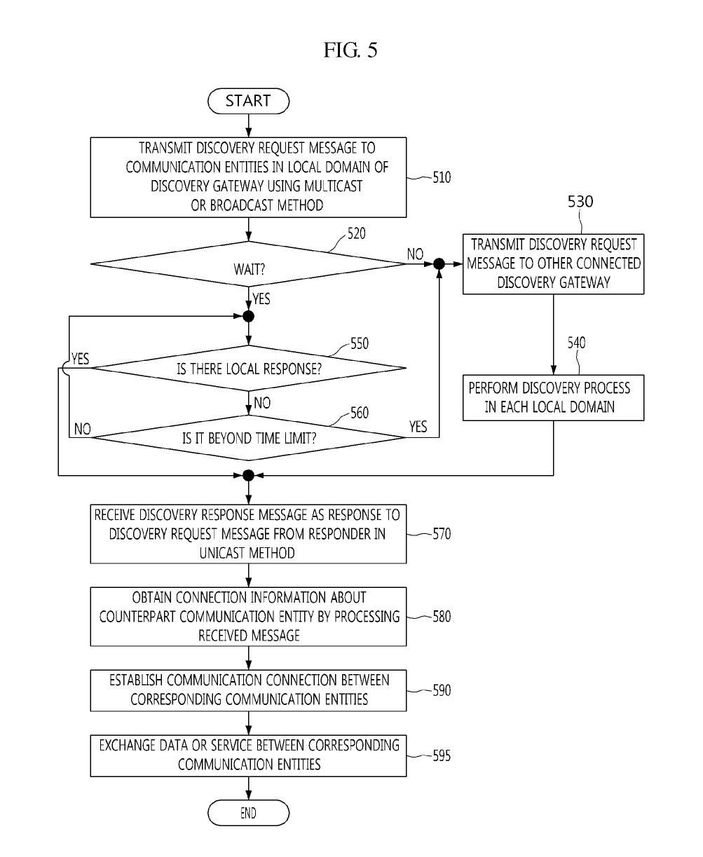

FIG. 3 is a schematic block diagram of a system for discovering a communication entity according to an example embodiment of the present invention. FIG. 4 is a flowchart illustrating a method of discovering a communication entity using a discovery gateway according to an example embodiment of the present invention, and FIG. 5 is a detailed flowchart illustrating the method of discovering a communication entity using a discovery gateway illustrated in FIG. 4.

A method of discovering a communication entity according to an example embodiment of the present invention may be applied when communication entities participating in an application domain and exchanging data or service are present on different local networks 102 and 108, the first local network 102 and the second local network 108 are connected via a passage network 105, and the passage network 105 does not support multicasting and broadcasting.

In the method of discovering a communication entity according to an example embodiment of the present invention, under the above condition, discovery gateways are provided in a first local domain 310 and a second local domain 320 respectively, and a first discovery gateway 103 in the first local domain 310 and a second discovery gateway 107 in the second local domain 320 are connected, so that a discovery function can be performed between all communication entities. Here, a discovery gateway is a functional distinction, and may be implemented in network devices 104 and 106 required for a local network to access the passage network 105, or in a separate device from the network devices 104 and 106.

The passage network 105 may be a public network that does not support multicasting and broadcasting due to network load.

The method of discovering a communication entity according to an example embodiment of the present invention enables communication entities requiring network-based interaction, such as data exchange and service provision, to discover information required for connecting with each other.

The method of discovering a communication entity according to an example embodiment of the present invention may be applied when data sharing between the first LAN 102 and the second LAN 108 is required in a state in which the first LAN 102 is connected with the second LAN 108 via a public network that does not support multicasting and broadcasting.

For example, the method of discovering a communication entity according to an example embodiment of the present invention may be applied to a smart grid, smart highway, intelligent building system (IBS), etc. so that countless communication entities participating in an application domain can share data.

Discovery gateways on different local networks may recognize each other in advance. This is possible because a management subject (e.g., a company or a research institute) to provide and manage application has understanding and previous knowledge of an entire network structure, and can know in which local networks communication entities to participating in an application domain are included when the application is designed/implemented.

Also, if the discovery gateways are integrally implemented with the network devices 104 and 106, the discovery gateways may recognize each other later by transmitting a message informing each other of the presence of a discovery gateway during communication between the network devices 104 and 106 on local networks.

The overall process of the method of discovering a communication entity according to an example embodiment of the present invention will be described below with reference to FIGS. 3 and 4. First, when communication entities participating in an application domain and exchanging data or service are on the different local networks 102 and 108, the first local network 102 and the second local network 108 are connected via the passage network 105, and the passage network 105 does not support multicasting and broadcasting, the discovery gateways 103 and 107 are provided in the first local domain 310 and the second local domain 320, respectively (step 410).

The requestor 101 processes a discovery request by transmitting a discovery request message to communication entities in the first local domain 310 using the multicast or broadcast scheme in the first local domain 310 (step 420).

The first discovery gateway 103 in the first local domain 310 transmits the discovery request to the second discovery gateway 107 in the second local domain 320 via the passage network 105 that does not support multicasting and broadcasting (step 430).

The second discovery gateway 107 in the second local domain 320 processes the discovery request by multicasting or broadcasting in the second local domain 320 (step 440).

The method of discovering a communication entity according to an example embodiment of the present invention will be described below in further detail with reference to FIGS. 3 and 5.

When communication entities on the first local network 102 belong to a multicasting group in the local domain of the requestor 101, that is, the first local domain 310, the requestor 101 transmits a discovery request message to communication entities belonging to the group in the first local domain 310 through a group communication channel 121 using the multicast scheme to process the discovery request. When communication entities on the first local network 102 do not belong to a multicasting group in the first local domain 310, the requestor 101 transmits the discovery request message to all the communication entities on the first local domain 310 through the group communication channel 121 using the broadcast scheme to process the discovery request (step 510). Here, a multicasting group may include communication entities for a specific application (e.g., a smart grid) among communication entities in a local domain.

It is determined whether or not the first discovery gateway 103 is set to first process a result of discovery in the local network of the first discovery gateway 103 itself and thus needs to wait (step 520). When the first discovery gateway 103 is set to first process a result of discovery in the first local network 102 and thus needs to wait, it is determined whether or not there is a response from communication entities in the local network of the first discovery gateway 103 (step 550). When it is determined that there is no response, it is determined whether it is beyond a time limit (step 560).

When it is determined that it is beyond the time limit or the first discovery gateway 103 simultaneously performs discovery on the local network of the first discovery gateway 103 itself and another local network, the first discovery gateway 103 transmits the received discovery request message to all discovery gateways connected with the first discovery gateway 103 itself through a unicast channel 122 (step 530). Here, the first discovery gateway 103 may transmit the discovery request to another local network after analyzing a result of discovery in the local network of the first discovery gateway 103 itself, or simultaneously transmit the discovery request to the local network of the first discovery gateway 103 itself and another local network.

As a discovery requestor, a discovery gateway receiving the discovery request message on the other local network transmits the discovery request message to communication entities on the local network of the discovery gateway itself using the multicast or broadcast scheme to perform a discovering process (step 540). In other words, a discovering process is performed in each local domain. A case in which the other local network is the second local network 108 will now be described as an example of the discovering process in each local domain. As a discovery requestor on the second local network 108, the second discovery gateway 107 receiving the discovery request message performs a communication entity discovery process of transmitting the discovery request message to communication entities on the second local network 108 through a group communication channel 123 using the multicast or broadcast scheme, and receiving a discovery response message from the corresponding communication entity through a unicast channel 124. When no connection information or result is discovered on the second local network 108, a discovery response message indicating that there is no corresponding communication entity is transmitted to the first discovery gateway 103, which has transmitted the discovery request message for the first time, through a unicast channel 125. When an actual communication entity is successfully discovered and the first discovery gateway 103 receives connection information about a counterpart communication entity 111, the connection information is transferred to a communication entity 110 served by the first discovery gateway 103. Subsequently, the communication entity 110 that has transmitted the discovery request message for the first time establishes a connection 127 for exchanging data with the counterpart communication entity 111 on the basis of the connection information and performs data exchange.

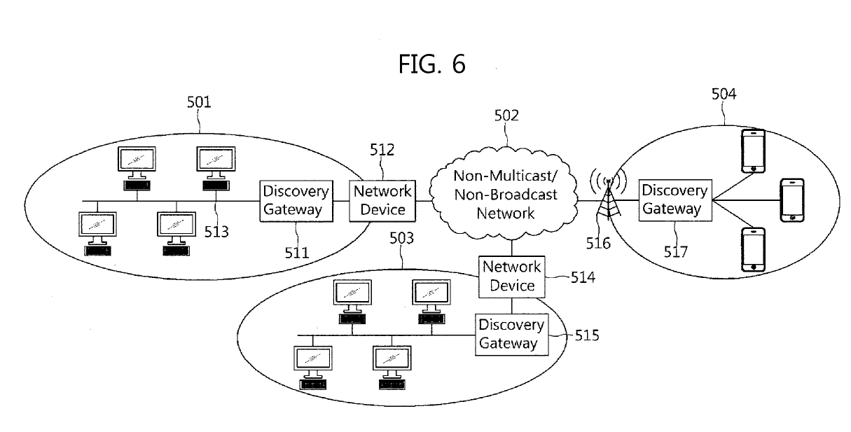

FIG. 6 is a conceptual diagram illustrating an example of a network environment to which a method of discovering a communication entity using a discovery gateway according to an example embodiment of the present invention is applied, and provision of discovery gateways.

Referring to FIG. 6, communication entities participating in an application domain are on local networks 501, 503 and 504, and the local networks 501, 503 and 504 are connected via a passage network 502 that does not support multicasting and broadcasting. When a communication entity 513 on one local network 501 transmits a discovery request message, a discovery gateway 511 serving the local network 501 transmits the discovery request message to all discovery gateways 515 and 517 connected with the discovery gateway 511 itself and waits for the results. Subsequently, the discovery gateways 515 and 517 connected with the discovery gateway 511 perform a communication entity discovery process in the local networks 503 and 504 served by the discovery gateways 515 and 517 respectively, and transfer the results to the discovery gateway 511 that has made the discovery request.

In the method of discovering a communication entity according to example embodiments of the present invention, when a passage network connecting at least one first communication entity in a first local domain with at least one second communication entity in a second local domain does not support a broadcast scheme and a multicast scheme, the discovery gateways are introduced such that communication entities participating in an application domain can perform a discovery process, which includes a discovery request between communication entities for data or service exchange and transfer of a result as a response to the discovery request, in a distributed structure separately from sub-network management.

Also, a distributed discovery process through requests/responses between participating communication entities can be performed separately from a communication scheme supported by a sub-network, thereby obtaining stability and reliability of overall application as well as a discovery process.

Even when a passage network that does not support broadcasting and multicasting is between two communication entities, a method of discovering a communication entity to according to example embodiments of the present invention enables a communication entity to search for connection information about a counterpart communication entity without information required for communication entities requiring interaction on a network to connect with each other, thereby performing functions such as data exchange and service provision at a global level.

In a method of discovering a communication entity according to example embodiments of the present invention, when some networks between nodes operated by communication entities requiring interaction do not support a multicast scheme and a broadcast scheme, discovery gateways are introduced to handle the networks that do not support multicasting and broadcasting. Thus, the discovery gateways connect with each other to transfer and process a discovery-related message, thereby enabling discovery of a communication entity and the interaction.

While the example embodiments of the present invention and their advantages have been described in detail, it should be understood that various changes, substitutions and alterations may be made herein without departing from the scope of the invention.

What is claimed is:

1. A method of discovering a communication entity using a discovery gateway, the method comprising:
when a passage network connecting at least one first communication entity in a first local domain with at least one second communication entity in a second local domain does not support the broadcast scheme and the multicast scheme, transmitting, by a first discovery gateway, a discovery request to a second discovery gateway in the second local domain via the passage network, the second discovery gateway being one of all discovery gateways to connected with the first discovery gateway.

2. The method of claim 1, wherein transmitting, by the first discovery gateway, the discovery request to the second discovery gateway in the second local domain via the passage network includes transmitting, by the first discovery gateway, a discovery request message to the second discovery gateway using a unicast scheme.

3. The method of claim 1, further comprising transmitting, by the first communication entity, a discovery request message to the first discovery gateway in the first local domain.

4. The method of claim 3, wherein transmitting, by the first communication entity, the discovery request message to the first discovery gateway in the first local domain includes transmitting, by the first communication entity, the discovery request message to the first discovery gateway in the first local domain through group communication.

5. The method of claim 1, wherein transmitting, by the first discovery gateway, the discovery request to the second discovery gateway in the second local domain via the passage network includes:
when communication entities in the first local domain belong to a multicasting group, transmitting, by the first communication entity, the discovery request to the communication entities belonging to the multicasting group in the first local domain through group communication using the multicast scheme; and
when the communication entities in the first local domain do not belong to a multicasting group, transmitting, by the first communication entity, the discovery request to all the communication entities in the first local domain through group communication using to the broadcast scheme.

6. The method of claim 1, further comprising recognizing the first discovery gateway provided in the first local domain and the second discovery gateway provided in the second local domain by each other.

7. The method of claim 1, wherein the first and second discovery gateways are provided such that a local network is identified from information about all of networks in which communication entities participating in an application domain are present and a discovery gateway for the local network is provided.

8. The method of claim 1, wherein the first discovery gateway is integrally implemented with a network device for interoperation between a first local network in the first local domain and the passage network.

9. The method of claim 1, wherein the first discovery gateway transmits the discovery request to the second local domain after analyzing a result of discovery in the first local domain.

10. The method of claim 1, wherein the first discovery gateway simultaneously transmits the discovery request to the first local domain and the second local domain.

11. The method of claim 1, further comprising processing, by the second discovery gateway, the discovery request with the second communication entity in the second local domain using one of the multicast scheme and the broadcast scheme.

12. The method of claim 11, wherein processing, by the second discovery gateway, the discovery request with the second communication entity in the second local domain using one of the multicast scheme and the broadcast scheme includes:
when the second discovery gateway receives the discovery request from the first gateway, transmitting, by the second discovery gateway as a requestor, the discovery request to at least one communication entity in the second local domain using one of the multicast scheme and the broadcast scheme;
receiving, by the second discovery gateway, a discovery response message from the at least one communication entity in the second local domain using a unicast scheme; and
when no connection information or result is discovered in a second local network, transmitting, by the second discovery gateway, a discovery response message indicating that there is no connected communication entity to the first discovery gateway using the unicast scheme.

13. A communication entity discovery system for performing a method of discovering a communication entity using a discovery gateway, the system comprising:
at least one first communication entity in a first local domain; and
a first discovery gateway provided in the first local domain,
wherein, when a passage network connecting the at least one first communication entity with at least one second communication entity in a second local domain does not support the broadcast scheme and the multicast scheme, the first communication entity transmits a discovery request message to the first discovery gateway, and the first discovery gateway transmits a discovery request to a second discovery gateway in the second local domain via the passage network, the second discovery gateway being one of all discovery gateways connected with the first discovery gateway.
